(19) United States
(12) Patent Application Publication
(10) Pub. No.: US 2004/0151330 A1
(43) Pub. Date: Aug. 5, 2004

(54) Audio interface device for public address systems

(76) Inventor: John E. Lehmkuhl, Ontario, OR (US)

Correspondence Address: PEDERSEN & COMPANY, PLLC, P.O. BOX 2666, BOISE, ID, 83701, US

(21) Appl. No.: 10/359,341

(22) Filed: Feb. 4, 2003

(51) Int. Cl. H04R 5/00; H02B 1/00; H04B 3/00; H04B 1/00

(52) U.S. Cl. 381/123; 381/81; 381/1; 381/124

(57) ABSTRACT

The present invention has all the properties and capabilities of a standard direct-box, which is an audio adapter circuit in a rugged chassis. It allows high-impedance stereo headphones to be connected. It comes equipped with a switch that turns the signal to the exterior sound system on/off without interrupting sound to the headphones. The present invention also comes with a locking cover, which prevents inadvertent operation of additional switches, such as a ground lift switch or attenuation level switch. The cover also functions as a mounting structure.

### BACKGROUND OF THE INVENTION

1. Field of the Invention

This invention relates generally to audio devices and more particularly to electronic circuitry for “direct boxes” used to convert unbalanced, high impedance signals into balanced, low impedance signals for audio devices.

2. Related Art

Most audio producing devices, such as computers, cassette tape players, and personal electronic players, output an unbalanced, high impedance electrical signal. Such signals are vulnerable to electrical interference and cannot be sent over a long transmission line without serious deterioration in signal quality. This problem can be corrected by converting the unbalanced, high impedance signal into a balanced, low impedance signal with a device known as a “direct box.” This conversion is also often a necessity as many amplifiers and speakers are designed for a balanced, low impedance signal.

An example of such a device is disclosed by Kampes (U.S. Pat. No. 4,737,735). This device uses a non-inverting amplifier and voltage follower circuit. Unlike the present invention, it relies upon active electronic components in order to function.

Numerous direct boxes are available commercially. Typical of these is the Rolls DB-25. It is a passive device that converts an unbalanced, high-impedance signal into a balanced, low-impedance signal and vice-versa. Unlike the present invention, it cannot provide conversion of two stereo input signals into a single, summed and balanced monaural output signal. Nor does the Rolls DB-25 provide a stereo headphone output or a shut-off switch, as does the present invention.

Another related direct box is the pcDI Stereo Direct Box manufactured by Whirlwind Music Distributing, Inc. of Rochester, N.Y. It features two input connector jacks, but has no monaural output or headphone capability, no shut-off switch, and no cover, as does the present invention.

The novel features of the present invention dramatically increase the usefulness in courtrooms, public address, and other presentation venues. No other such devices have been found that incorporate the features and benefits of the present invention in such a way as to provide such a high level of utility as described in the following specification.

### SUMMARY OF THE INVENTION

The present invention is an audio interface device, commonly known in the industry as a direct box. The particular features of this invention allow stereo high-impedance headphones to faithfully reproduce stereo input signals, while at the same time providing a monaural, balanced, low-impedance output to an external sound system. It features a disconnect switch that turns the signal to the external sound system on and off without interrupting the sound to the headphones.

The features of the aforementioned embodiment, plus other embodiments, aspects, advantages and features of the present invention will be set forth in part in the description, and in part will come to those skilled in the art by reference to the following description of the invention and referenced drawings, or by practice of the invention.

### BRIEF DESCRIPTION OF THE DRAWINGS

FIG. 1 is a schematic diagram of the circuitry contained in the preferred embodiment of the present invention.

FIG. 2a is a right-side view of the outside case and controls of the preferred embodiment of the present invention.

FIG. 2b is a left-side view of the outside case and controls of the preferred embodiment of the present invention.

FIG. 2c is a top view of the outside case and controls of the preferred embodiment of the present invention with the cover removed to show the controls.

FIG. 3a is a front view of the outside case of the preferred embodiment with the cover secured over the controls located on the top.

FIG. 3b is a front view of the outside case of the preferred embodiment with the cover pivoted away from the controls located on the top.

### DETAILED DESCRIPTION OF THE INVENTION

The present invention is an audio adapter circuit in a rugged chassis. It is known as the “direct box,” and has been developed by the inventor specifically for the needs of courtrooms and convention centers. Court personnel making electronic recordings of court proceedings typically listen to the audio being recorded on a ½ second delay to insure that the audio signal is being received by the recording equipment. The preferred embodiment of the invention includes a standard headphone jack with a constant audio output.

Often, it is necessary to playback earlier proceedings. Until now, there has been no convenient way to play the audio recording directly back over the courtroom's speaker system. The present invention creates a direct and high-quality connection between the courtroom's recording and playback device and the public address system. By making use of this invention, the court reporter is able to listen to the sounds being broadcast over the courtroom's sound systems and simultaneously recorded, whether live proceedings or earlier recorded proceedings. The invention allows the user to continuously record court proceedings while also replaying earlier proceedings. The preferred embodiment of the invention includes a second, low impedance output signal to the courtroom's audio system that can be turned on as needed to replay earlier recorded proceedings.

Convention centers typically have the capability to project video presentations from a computer, but cannot connect directly provide digital audio recordings that are included in the presentation. The present invention allows the user to connect a computer, cassette record/playback device, or other personal audio device to any microphone outlet by way of a standard XLR mic/line connector mounted on the chassis of the present invention. Also, the invention allows the presenter to listen to his audio recording and check that it is correct without having that audio broadcast over the room's audio system.

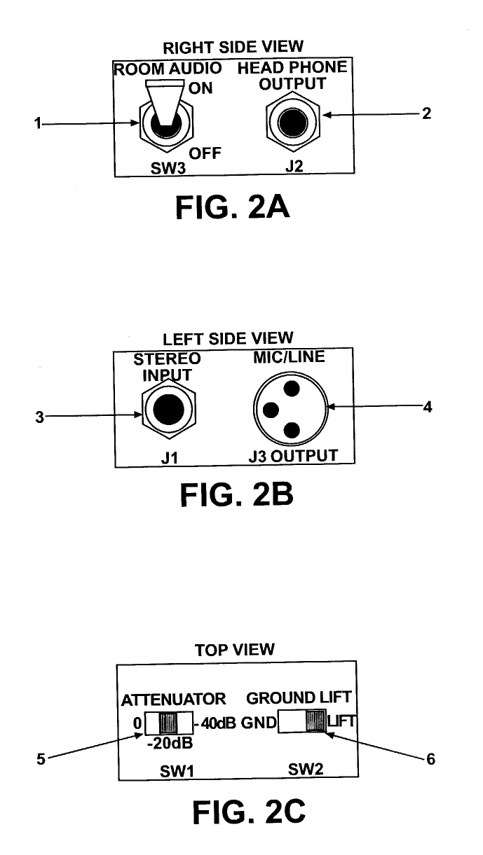

FIG. 2a is a right-side view of the outside case and controls of the preferred embodiment of the present invention. It features a two-position toggle-switch SW3 1 that, when switched to the on position, allows the input signal to be passed through a balancing transformer to the mic/line output, which is typically used as the signal source in a room sound system. When switched to the off position, toggle-switch SW3 1 disconnects the input signal from the XLR Mic/Line Output connector. Headphone output connector J2 2 provides a stereo output for the use of standard headphones. In the preferred embodiment, this stereo output plug is a standard 3.5 mm size.

FIG. 2b is a left-side view of the outside case and controls of the preferred embodiment of the present invention. On this panel face of the chassis, Stereo Input connector J1 3 also accepts a standard 3.5 mm sized stereo jack, and is the main signal input connection. Next to the main input connection the industry-standard XLR-type Mic/Line output connector J3 4 is located. Its three terminals connect to a balanced driver transformer and to chassis ground.

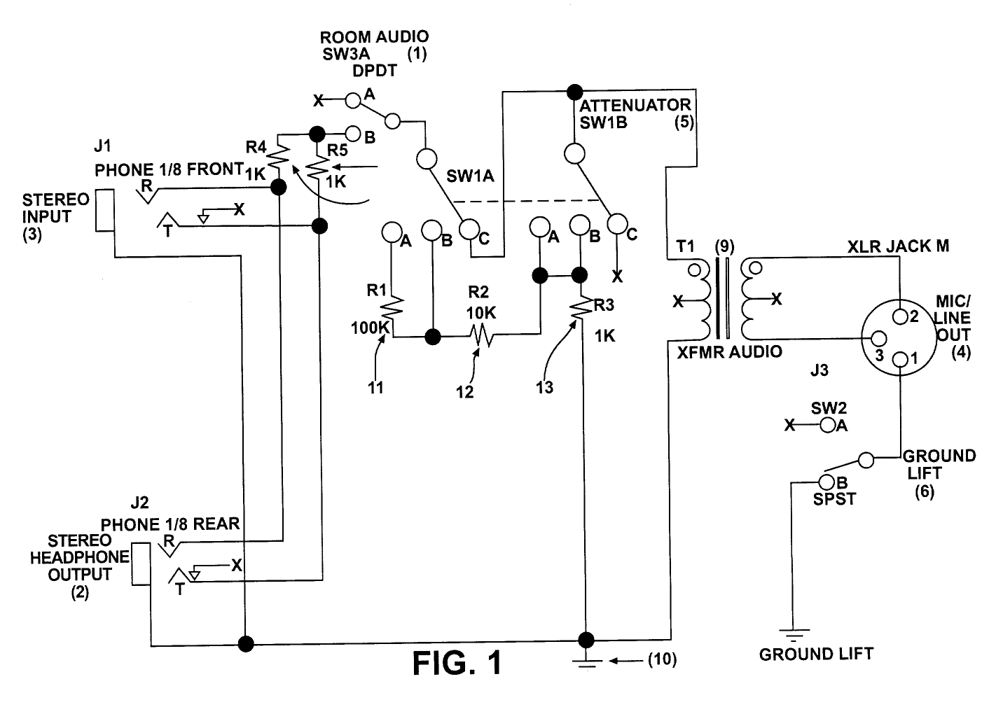

FIG. 1c is a top view of the outside case and controls of the preferred embodiment of the present invention. The three-position switch, SW1 5 allows the setting of three different attenuation levels for the output signal; 0 dB, −20 dB, and −40 dB. Two-position switch, SW2 6 allows for isolation of the Mic/Line Output connector 4 from chassis ground. In the GND position, the ground pin of the Mic/Line Output connector 4 is connected to the chassis ground, and in the LIFT position, it is isolated from chassis ground.

FIG. 1 is a schematic diagram of the circuitry contained in the preferred embodiment of the present invention. In this figure, the input signal would be connected on the left side and flow to the right. Stereo Input connector J1 3 Headphone output connector J2 2 each have three contacts; a grounding sleeve, a tip and a ring, (the industry standard Sleeve, Tip and Ring terminals). Tip and Ring connect the right and left channels between the two connectors directly while each Sleeve is connected to the chassis ground 10. Summing resistors R4 and R5 7 and 8 combine the left and right stereo signals into a single audio signal which connects to pole B of Room Audio switch SW3 1.

Room Audio switch SW3 1, when switched to the off position, disconnects the input signal from transformer T1 9 and Mic/Line Output connector 4. When switch SW3 1 is closed the audio signal is passed through Attenuator switch SW1 5. The function of Attenuator switch SW1 5 functions as follows:

In position A, the signal passes through attenuation resistors R1 11 and R2 12, with attenuation resistor R3 13 shunting signal energy to ground. This combination provides −40 dB of attenuation.

In position B, the signal passes through attenuation resistors R2 12, with attenuation resistor R3 13 shunting signal energy to ground. This combination provides −20 dB of attenuation.

In position C, the signal passes directly through to transformer T1 9 with zero dB of attenuation.

On the primary (left-side) of transformer T1 9, the audio signal is referenced to chassis ground 10, while both output pins on the secondary (right-side) of provide isolated output signals to Mic/Line Output connector 4.

Again, two-position switch, SW2 6 allows for isolation of the Mic/Line Output connector 4 from chassis ground. In the GND position (B), the Ground pin (pin 1) of the Mic/Line Output connector 4 is connected to the chassis ground 10, and in the LIFT position, it is isolated from chassis ground 10.

The nominal frequency response of the transformer T1 9 is 25 Hz to 20 kHz, +0 dB, −3 dB. The insertion loss of the present invention is less than 0.5 dB. Its nominal output impedance is 600 ohms.

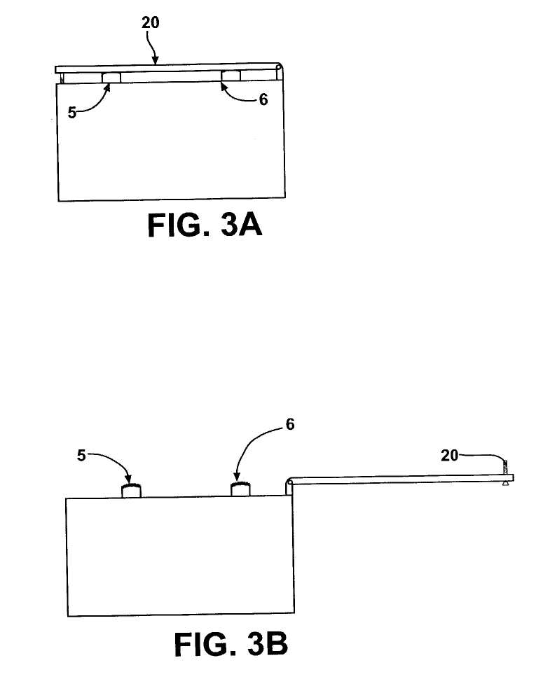

Another feature of the preferred embodiment, illustrated in FIGS. 3a and 3b, is a hinged cover 20 that can be screwed shut to prevent inadvertent operation of the Attenuator 5 and Ground Lift 6 switches depicted in FIG. 1c. This feature allows initial settings to be retained for permanent installations. The cover 20 also functions as a mounting structure, which can be conveniently attached underneath desktops or countertops.

The advantages of this invention will be beneficial for courtroom and other public address applications. Although this invention has been described above with reference to particular means, materials and embodiments, it is to be understood that the invention is not limited to these disclosed particulars, but extends to all equivalents within the field of this invention.

I claim:

1. In a direct box having the ability to convert a high impedance signal into a low impedance signal, the combination of said direct box with:
two output signals, a first output signal and a second output signal; and
a switch allowing said first output signal to be connected or disconnected without interrupting said second signal.

2. A combination according to claim 1, with circuitry for combining left and right hand stereo signals into a single monaural audio signal.

3. A combination according to claim 1, where said first output signal is a monaural signal and said second output signal is a stereo signal.

4. A combination according to claim 1, with a switch for changing attenuation levels for said first or said second output signals.

5. A combination according to claim 1, with a ground lift switch.

6. A combination according to claim 4, wherein said switch is a three-position switch.

7. A combination according to claim 6, wherein settings for said switch are 0 dB, −20 dB, and −40 dB.

8. A combination according to claim 1, with:
an additional switch; and
a cover that may be secured over said ground lift switch and said attenuation level switch that prevents said switches from being manipulated while said cover is in place.

9. A combination according to claim 8, wherein said additional switch is a switch for changing attenuation levels for said first or said second output signals.

10. A combination according to claim 8, wherein said additional switch is a ground lift switch.

11. A combination according to claim 9, wherein said switch is a three-position switch.

12. A combination according to claim 6, wherein settings for said switch are 0 dB, −20 dB, and −40 dB.

13. In a direct box having the ability to convert a high impedance signal into a low impedance signal, the combination of said direct box with:
a plate that covers a switch on said direct box such that said switch cannot be moved while said cover is in place.

14. A combination according to claim 13, where said switch is a switch for changing attenuation levels for the output signal.

15. A combination according to claim 13, where said switch is a ground lift switch.

16. A combination according to claim 14, wherein said switch is a three-position switch.

17. A combination according to claim 6, wherein settings for said switch are 0 dB, −20 dB, and −40 dB.
